(19) United States
(12) Patent Application Publication
(10) Pub. No.: US 2015/0319232 A1
(43) Pub. Date: Nov. 5, 2015

(54) PEER-TO-PEER MESSAGING SYSTEM

(71) Applicant: Joseph SIBONY, Brookville, NY (US)

(72) Inventor: Joseph SIBONY, Brookville, NY (US)

(21) Appl. No.: 14/266,226

(22) Filed: Apr. 30, 2014

(51) Int. Cl. H04L 29/08; G06F 3/0484; H04L 12/58; G06F 3/0482

(52) U.S. Cl. CPC H04L 67/104; G06F 3/0482; G06F 3/04842; H04L 51/046

(57) ABSTRACT

A messaging system is provided. The messaging system may include a plurality of computers with a user interface, at least one program products and a message manager having an album menu adapted to bundle and embed at least one data set into a single peer-to-peer message or an album. The messaging system may be performed by a computer acting as a sending peer and at least one computer acting as the recipient peer. The sending peer may open the album menu on the user interface, wherein the sending peer selects at least one intended recipient peer and the at least one data set to form at least one album. Next the sending peer transmits a single or multicast album, which may be received at one or more recipient peer, so that the at least one recipient peer may open, view and save the subject matter of the messaged album.

### BACKGROUND OF THE INVENTION

The present invention relates to computer networks and, more particularly, to peer-to-peer messaging systems.

Currently, peer-to-peer messaging systems send discrete data or messages, such as an image, a video or text, between users. Such messaging systems are limited by the ability to transfer more than one discrete data or message at a time. This means that messages must be split up or sent and or received in non-optimal sequence, depriving users of sharing fuller, multi-media/data experiences in one message.

As can be seen, there is a need for a peer-to-peer messaging system able to transfer more than one image, video and text at a time in one message, eliminating the need for several messages or communications.

### SUMMARY OF THE INVENTION

In one aspect of the present invention, a system for transmitting a plurality of data in one message in a peer-to-peer platform, comprises: a plurality of computers, each having a user interface; and a program product comprising machine-readable program code for causing, when executed, the plurality of computers to perform the following process steps: participating with at least one other program product to form a peer-to-peer platform comprising peer-to-peer protocols for communicating with each other so as to share a plurality of data sets in the peer-to-peer platform; producing on at least one user interface an electronic representation of a plurality of data sets formatted for sharing in the peer-to-peer platform; prompting a user to select at least one data set for sharing in the peer-to-peer platform; prompting a user to select at least one receiving peer to communicate with in the peer-to-peer platform; forming at least one album from the selected at least one data set; and transmitting the at least one album in the peer-to-peer platform to the at least one receiving peer.

In another aspect of the present invention, a method of delivering east-to-view bundles of at least one data set so as to eliminate the need for sending several messages, comprises providing a plurality of computers, each having a user interface; providing a program product configured to participate with at least one other program product to form a peer-to-peer platform comprising peer-to-peer protocols for communicating with each other so as to share a plurality of data sets in the peer-to-peer platform; producing on at least one user interface an electronic representation of a plurality of data sets formatted for sharing in the peer-to-peer platform; selecting at least one data set from the at least one user interface for sharing in the peer-to-peer platform; selecting at least one receiving peer to communicate with in the peer-to-peer platform; forming at least one album from the selected at least one data set; and transmitting the at least one album in the peer-to-peer platform to the at least one receiving peer.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention; and

FIG. 4 is a flowchart of an exemplary embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a messaging system. The messaging system may include a plurality of computers with a user interface, at least one program products and a message manager having an album menu adapted to bundle and embed at least one data set into a single peer-to-peer message or an album. The messaging system may be performed by a computer acting as a sending peer and at least one computer acting as the recipient peer. The sending peer may open the album menu on the user interface, wherein the sending peer selects at least one intended recipient peer and the at least one data set to form at least one album. Next the sending peer transmits a single or multicast album, which may be received at one or more recipient peer, so that the at least one recipient peer may open, view and save the subject matter of the messaged album.

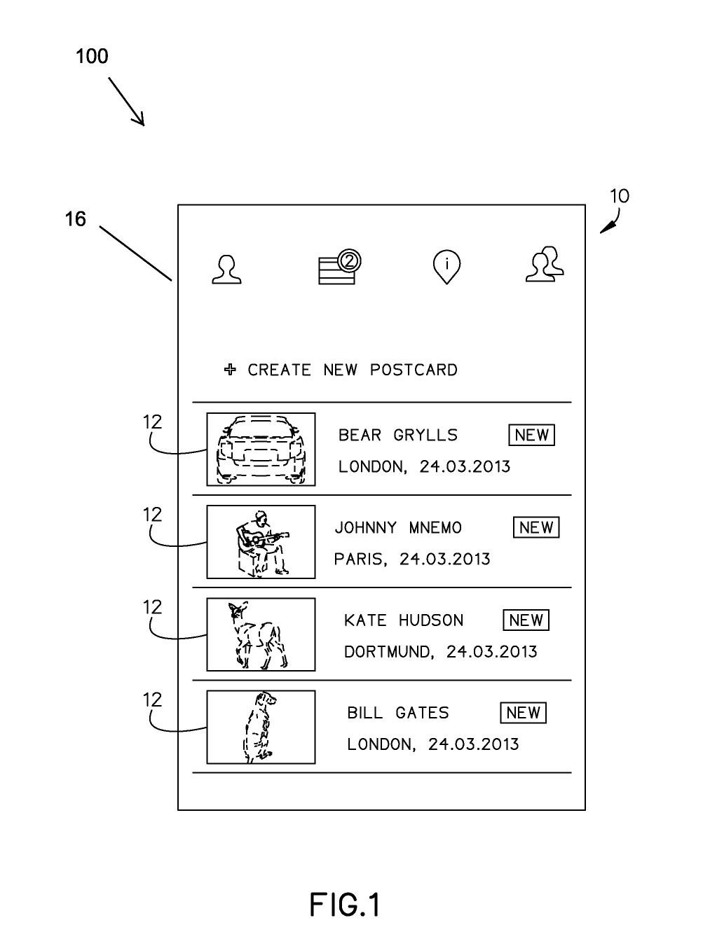

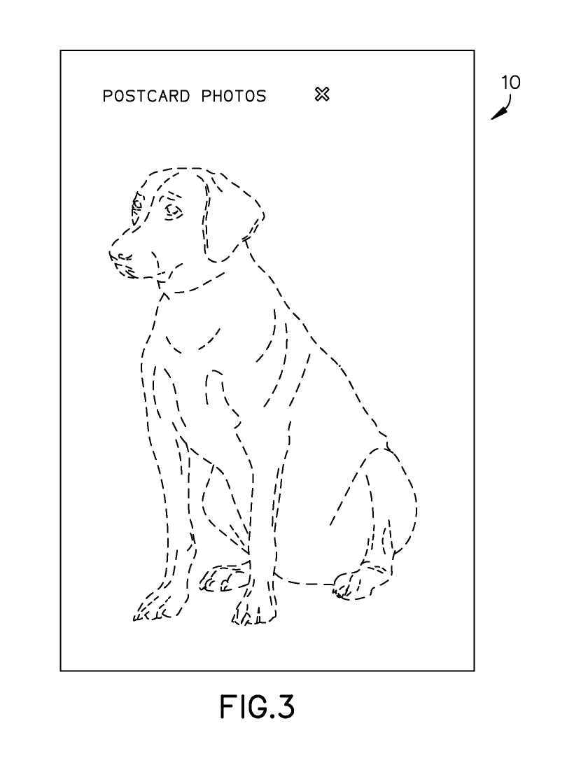

Referring to FIGS. 1 through 3, the present invention may include a messaging system 100. The messaging system 100 may include a plurality of computers with a user interface. Each computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The program product may run on the plurality of computers. The program product may interact with an operating system of each computer. These program products may support numerous services or functions such as, for example, document sharing, file transfer, remote control, voiceover Internet Protocol (IP), user authentication, address book, files and folders, database management, etc. These program products may also support a website or web server for distribution of web pages and access to back-end applications. Each program products may be a network application which may require efficient and reliable real-time data communication between the plurality of computers during operation of the messaging system 100.

Each program product and/or computer may support peer-to-peer messaging within the messaging system 100 by communicating and/or exchanging messages including at least one data set 12 between other program products and/or computers. Each program product and/or computer may include a number of modules or components which enable the exchange of the at least one data set 12 with other program products, including may utilize a Hyper Text Transfer Protocol (HTTP) and/or peer-to-peer protocols known in the art. The at least one data set 12 may include text files, photographs, applets, executable files, serialized Java objects, SOAP messages, generate audio and video data and the like.

Each program product and/or computer may include a message manager. The message manager may coordinate or manage the handling of messages which may be transmitted from or received by each program product and/or computer so that the at least one data set 12 may be seamlessly bundled so as to eliminate the need for several messages or communications. The message manager may coordinate the at least one data set 12 so as to simultaneously deliver and/or electronically represent the at least one data set 12 on the user interface.

The message manager may include a number of modules for supporting or providing this message handling functionality that, for example, controls the flow of data or information through it associated program product and/or computer. The message manager may coordinate and/or group at least one data set 12 from the various program products and/or computers so the plurality of at least one data set 12 may reach the proper recipient as an album 10 including the plurality of at least one data set 12. In certain embodiments, the album may include at least one data set 12 from one program product and/or computer. The message manager may coordinate the at least one album 10 so as to simultaneously deliver and/or electronically represent the at least one album 10 on the user interface.

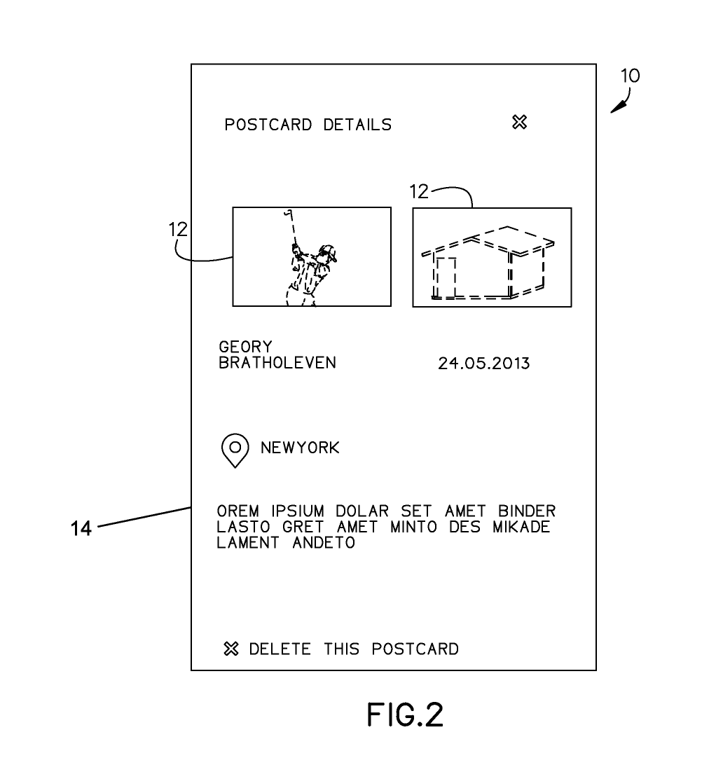

What makes the messaging system 100 unique may be that it contains methods for adapting the delivery of easy-to-view packages, bundles or albums 10 containing at least one data set 12, eliminating the need for several messages or communications. The program product may generate a wrapper in accordance with peer-to-peer protocol for wrapping the at least one data into the album 10. The album 10 may include personalized at least one data set 12, for example, including a photo, video and text data embedded in a simple, easy-to-use message, as illustrated in FIG. 2. The program product and/or computer may include a video and image viewer embedded therein. The messaging system 100 may make the viewing of video and image files inside of an album simpler and more integrated. The messaging system 100 may provide an all-in-one solution for users for sharing experiences with others. For example, the program product and/or computer may include a postcard feature. The postcard feature may enable an album menu 16 through the user interface so that a user may create at least one virtual postcard 14 from at least one data set 12 found on the computer and/or network. The resulting virtual postcards 14 may include images and video as well as some accompanying text.

In certain embodiments, the program product and/or computer may determine the location of a sending computer. Most computers, especially mobile devices, may have built-in navigational components, such as an accelerometer, a gyroscope, magnetometer and global positioning systems (GPS). The program product and/or computer may continuously determine the location of the sending computer, in motion or at rest, by filtering the navigational components of the sending computer. The program product and/or computer may virtual stamp at least one virtual postcard 14 with the location of the sending computer so that the

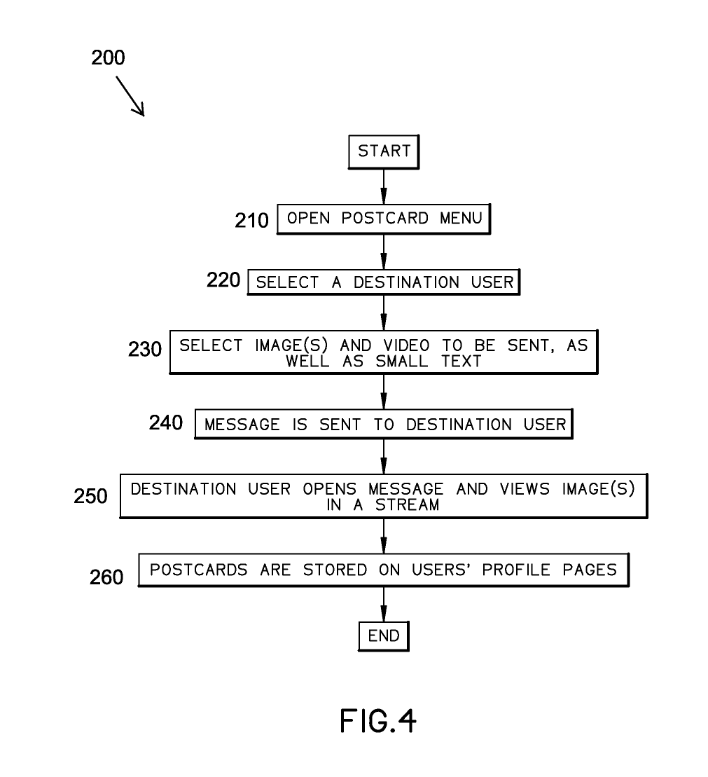

Referring to FIG. 4, a method 200 of using the present invention may include the following. The messaging system 100 disclosed above may be provided. The messaging system 100 may be performed by the program product and/or the computer acting as a sending peer and at least one computer acting as the recipient peer. Method 200 begins at step 210 where the sending peer may open the album menu 16 on the user interface. At step 220 the sending peer may select at least one intended recipient peer. The at least one intended recipient peer may be on a defined network and/or communication link, such as for example an Intimate City Network comprised of a select group of recipient peers. At step 230 the sending peer may select at least one data set 12 to form the album 10. Step 220 and 230 may be sequentially interchanged. At the next step 240, the sending peer may transmit a single or multicast album 10. The multicast album may be the transmission of one album 10 to a plurality of recipient peers. In certain embodiments, the multicast album by be the transmission of a plurality of albums 10 to the plurality of recipient peers. The messaged album 10 may be related to a particular subject, which may be specified in the body component of the messaged album 10. At step 250 the messaged album 10 may be received at one or more recipient peer, whereby the recipient peer may open and view the subject matter of the messaged album 10. At step 260, at least one recipient peer may store the messaged album 10.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for transmitting a plurality of data in one message in a peer-to-peer platform, comprising:
a plurality of computers, each having a user interface; and
a program product comprising machine-readable program code for causing, when executed, the plurality of computers to perform the following process steps:
participating with at least one other program product to form a peer-to-peer platform comprising peer-to-peer protocols for communicating with each other so as to share a plurality of data sets in the peer-to-peer platform;
producing on at least one user interface an electronic representation of a plurality of data sets formatted for sharing in the peer-to-peer platform;
prompting a user to select at least one data set for sharing in the peer-to-peer platform;
prompting a user to select at least one receiving peer to communicate with in the peer-to-peer platform;
forming at least one album from the selected at least one data set; and
transmitting the at least one album in the peer-to-peer platform to the at least one receiving peer.

2. The system of claim 1, further providing the process step of wrapping the at least one data set in a wrapper generated according to the one of the peer-to-peer protocols, forming the at least one album.

3. The system of claim 1, further providing the process steps of determining a location of the program product transmitting the at least album, and virtually stamping the location on the at least one album, forming at least one virtual postcard.

4. The system of claim 1, wherein the program product includes a message manager configured to coordinate the at least one album being transmitted and received.

5. A method of delivering east-to-view bundles of at least one data set so as to eliminate the need for sending several messages, comprising:
providing a plurality of computers, each having a user interface;
providing a program product configured to participate with at least one other program product to form a peer-to-peer platform comprising peer-to-peer protocols for communicating with each other so as to share a plurality of data sets in the peer-to-peer platform;
producing on at least one user interface an electronic representation of a plurality of data sets formatted for sharing in the peer-to-peer platform;
selecting at least one data set from the at least one user interface for sharing in the peer-to-peer platform;
selecting at least one receiving peer to communicate with in the peer-to-peer platform;
forming at least one album from the selected at least one data set; and
transmitting the at least one album in the peer-to-peer platform to the at least one receiving peer.

6. The method of claim 5, further including wrapping the at least one data set in a wrapper generated according to the one of the peer-to-peer protocols, forming the at least one album.

7. The method of claim 5, further including determining a location of the program product transmitting the at least album, and virtually stamping the location on the at least one album, forming at least one virtual postcard.

8. The method of claim 1, wherein the program product includes a message manager configured to coordinate the at least one album being transmitted and received.
